(19) United States
(12) Patent Application Publication
(10) Pub. No.: US 2006/0284724 A1
(43) Pub. Date: Dec. 21, 2006

(54) Device for receiving signals for controlling a function in a vehicle

(76) Inventors: Gerold Sept-Enzel, Stuttgart (DE); Ellen Hermsdorff, Werhau (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/571,050

(22) PCT Filed: Aug. 28, 2004
(86) PCT No.: PCT/EP04/09626

§ 371 Date: Mar. 3, 2006

(30) Foreign Application Priority Data
Sep. 4, 2003 (DE) 103411992

(51) Int. Cl. B60R 25/00

(52) U.S. Cl. 340/5.72; 343/860; 343/713; 340/5.64

(57) ABSTRACT

The invention relates to a device (1) for receiving signals for controlling a function in a vehicle, particularly for actuating the central locking of the vehicle, comprising an antenna (2), which receives the signals, and comprising an evaluation unit (5), which is connected down therefrom and which evaluates the received signals, and a control of the function ensues based on the evaluation of these signals. The invention provides that a matching unit (3) is connected between the antenna (2) and the evaluation unit (5) and matches the actual impedance of the antenna (2) to the input impedance of the evaluation unit (5).

This is an apparatus for receiving signals for controlling a function in a motor vehicle.

The invention relates to an apparatus for receiving signals for controlling a function in a motor vehicle, in particular, for operating the central-locking system of a motor vehicle, according to the features of the introductory clause of claim 1.

In motor vehicles, in particular cars, it is known to control functions remotely. To this end, the operator of the vehicle has a remote control that is, for example, integrated into the vehicle key. By operating this remote control, certain functions in the vehicle are controlled, in particular the central-locking system of the vehicle is operated in that it is possible to lock or unlock the vehicle. To this end devices are know that work with an infrared beam. The remote control has an infrared transmitter that must be aimed at an infrared receiver on the vehicle in order to control the function. This has the disadvantage that the transmitter must be accurately aimed at the receiver in order that the infrared beam hits the receiver. This is inconvenient in the vehicle since functions cannot be done when the transmitter is not accurately aimed at the receiver.

In order to overcome this problem, devices are known that use radio waves. This, however, creates the problem that other functions in the vehicle, for example radio reception, telephone and the like work with radio waves in the same frequency ranges. In order to separate adjacent frequency bands from each other an antenna or antenna unit is necessary in the vehicle that is tuned to the exact frequency or a narrow frequency range of the remote control of the central-locking system.

This necessitates an expensive and precise matching of the antenna and the associated circuitry. This matching is absolutely necessary, as otherwise errors occur. In modern motor vehicles it is also necessary to use a multiband antenna for several different functions. It is therefore for example, known to build into windshields, in particular into a back windshield of a motor vehicle, an antenna both for receiving radio signals and for controlling functions. Currently, for example, separate surface-mount conductor arrays are mounted on the rear windshield that must be tuned to the associated circuitry. This has above all the disadvantage that matching them to each other is extremely expensive since the slightest change in the antenna structure (for example, its length) and even other changes of its geometry (for instance the thickness of the windshield, the type of windshield, the thickness of the plastic are changed) in addition it is disadvantageous that different motor vehicles are equipped with different antenna structures so that with each shape a special matching must be done.

It is, therefore, an object of the invention to provide an apparatus for receiving signals for controlling a function in a motor vehicle, in particular for actuating the central-locking system of a motor vehicle, that does not have the above-given disadvantageous.

This object is attained by the features of claim 1.

According to the invention, there is between the antenna and the evaluating unit a matching unit that matches the actual impedance to an input impedance of the evaluating unit. This has the main advantage that any type of antenna or antenna structure can be used, and their different impedances can be altered by the matching unit so that they are all connectable to one and the same evaluating unit, that is a standard evaluating unit. To this end changes at the antenna or in the antenna structure as can result from tolerance variations, no longer have a bad effect on the control of the function. At the same time one has considerable freedom in design of the antenna or design of the antenna structure on the windshield or other surface of the motor vehicle, since it is no longer necessary to tune the to the input impedance of the evaluating unit.

In a further embodiment of the invention the matching device is passive or active, a passive matching unit being provided with passive electronic elements (for example coils and condensers) matched to the actual impedance of the antenna and the input impedance of the evaluating unit. The construction and use of an active matching unit has the advantage that it determines the actual impedance of the antenna and automatically matches this measured actual impedance to the input impedance of the evaluating unit. Such an active matching unit is of course set to compensate actively for disturbances produced by production tolerances.

An embodiment to which the invention is not restricted is described in the following and with respect to the figures. Therein:

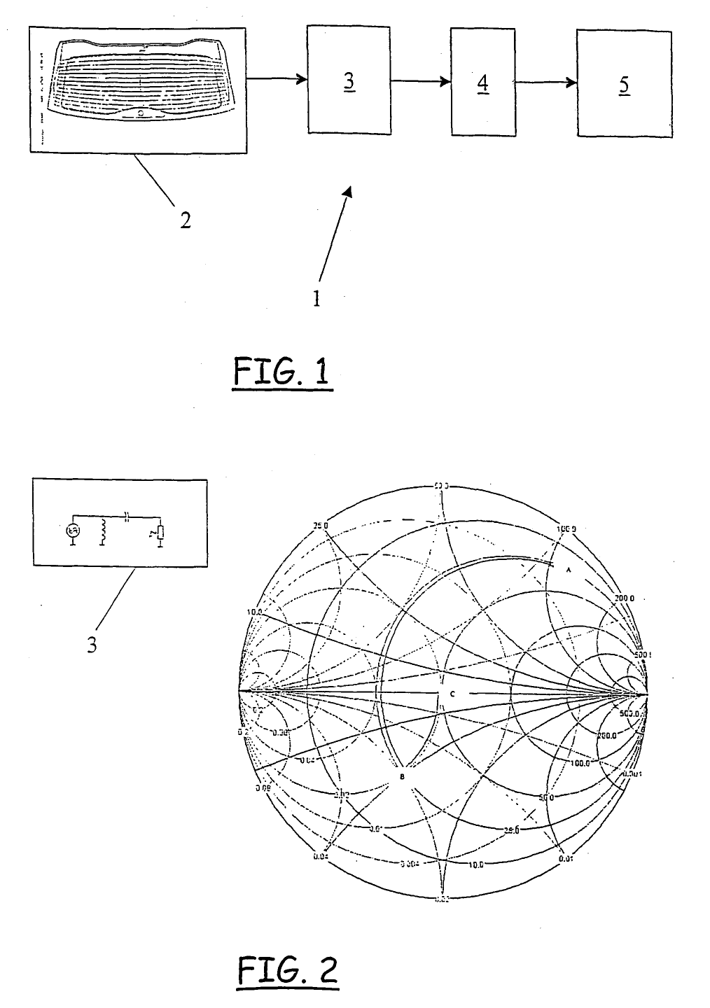

FIG. 1 is an apparatus according to the invention for receiving signals for controlling the central-locking system of a motor vehicle;

FIG. 2 is an illustration of the matching in a Smith chart by means of the matching unit according to the invention.

FIG. 1 shows by way of example the construction of an apparatus 1 for receiving signals for controlling functions in a motor vehicle, here for the actuation of the central-locking system of the motor vehicle. The elements of the central-locking system are not shown nor is the operating person who is equipped with a transmitter for emitting signals (radio waves). The signals emitted by this remote controller (transmitter) are received by an antenna 2 that is mounted in or on the motor vehicle. In the illustrated example, this is a rear windshield into which or on which the antenna structure is mounted. This rear windshield antenna is only by way of example, as other installation applications or other types of antennas are possible. According to the invention, the antenna 2 is connected to a matching unit 3 (matching network) to which the signals coming from the antenna 2 are fed. The matching unit 3 is in turn attached to a filter 4 which has the advantage that only the desired received signals are passed which are necessary for controlling the function in question. Thus other signals (as, for example, radio signals or even interference) do not get through the filter 4. Those signals which pass through the filter 4 get to a downstream evaluating unit 5 which evaluates the received signals and generates the required control signals which are fed to the operators of the central-locking system. This is known and is not the object of the invention so that further discussion of the functions of the central-locking system are not given here. In the matching unit 3 according to the invention, the actual impedance of the antenna 2 is modified such that it is the same as the input impedance of the evaluating circuit 5 so that there is a perfect matching of the antenna 2 and the evaluating circuit 5. This matching is shown in the Smith chart in FIG. 2 in which the actual impedance of the antenna 2 lies at point A which is modified by a passive element (condensers, coils) through the point B to the point C, the point C corresponding to the input impedance of the evaluating unit 5. With a passively function unit 3 it is thus possible once the actual impedance of the antenna 2 has been measured to select the elements of the matching unit 3 such that the matching unit 3 is ready for use in that the actual impedance of the antenna 2 (point A) is converted to the input to the evaluating unit 5 (point C).

With an actively working unit 3 the actual impedance of the antenna 2 is automatically determined and is automatically converted by a measuring unit for transformation from point A to point C.

In another embodiment it is also possible to integrate the matching unit 3, the filter 4 and/or the evaluating unit 5 into a filter module or to build them as a signal module.

### REFERENCE NUMERALS LIST

1 Apparatus for Receiving Signals
2 Antenna
3 Matching Unit
4 Filter
5 Evaluating Unit

1. An apparatus (1) for receiving signals for controlling a function in a motor vehicle in particular for actuating the central locking system of a motor vehicle, comprising an antenna (2) that receives the signals, and a downstream evaluating unit (5) which evaluates the received signals and in turn effects the necessary control action, characterized in that between the antenna (2) and the evaluating unit (5) there is a matching unit (3) that matches the actual impedance antenna (2) to an in put evaluating unit (5).

2. An apparatus (1) according to claim 1, characterized in that between the antenna (2) and the evaluating unit (5) there is a filter (4).

3. An apparatus (1) according to claim 1, characterized in that the matching unit (3) is passive.

4. An apparatus (1) according to claim 1 characterized in that the matching unit (3) is active and automatically determines the actual impedance of the antenna (2) and effects the matching.
